(19) United States
(12) Patent Application Publication
(10) Pub. No.: US 2008/0087742 A1
(43) Pub. Date: Apr. 17, 2008

(54) Surface cooling device

(76) Inventor: Chin-Chang Cheng, Fongyuan City (TW)

Correspondence Address: PHILLIP LIU, 6980, WHITEOAK DR., RICHMOND, BC, V7EAZ9, US

(21) Appl. No.: 11/903,702

(22) Filed: Sep. 25, 2007

(30) Foreign Application Priority Data
Oct. 13, 2006 (TW) 095218081

(51) Int. Cl. E01H 3/04; B05B 15/06

(52) U.S. Cl. 239/202; 239/275; 239/550

(57) ABSTRACT

A surface cooling device includes a cover fixed to a surface and a pipe is engaged with a groove an underside of the cover. A plurality of nozzles are rotatably connected to the pipe and located in outlets defined through the cover. The nozzles spray water particles to the air to cool the surface such as a road.

### FIELD OF THE INVENTION

The present invention relates to a surface cooling device which is fixed on the road and including rotatable nozzles to spray water particles out from the device to cool the road and reduce dust in the air.

### BACKGROUND OF THE INVENTION

A conventional cooling device for a space is generally includes a pipe which is fixed to a high position and a pressure device such as a pump is connected with the pipe so as to pressurize the water in the pipe. The pipe includes multiple outlets from which the pressurized water sprays and the water is ejected out in a form of small particles which are quickly merged into the air to cool the air and keep the air at certain humidity. The position of the pipe cannot be too low to be hit by people and goods, and cannot be too high where the water particles are blown away.

However, there is no cooling device designed for cooling the road surface, the conventional way known to applicant is to cool the roads is to spread water on the road. It is difficult to control the volume of water to be spread and the cooling area is limited.

The present invention intends to provide a surface cooling device which is fixed on the road and includes a pipe covered by a hard cover, rotatable nozzles are connected to the pipe and spray water particles from outlets in the cover.

### SUMMARY OF THE INVENTION

The present invention relates to a surface cooling device that comprises a cover fixed to a surface and a groove is defined in an underside of the cover. A pipe is engaged with the groove and a plurality of nozzles are connected to the pipe. A plurality of outlets are defined through the cover and communicate with the groove so that the nozzles are engaged with the outlets. The nozzles spray water particles out from the outlets to cool the surface.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the cover and the pipe of the surface cooling device of the present invention;

FIG. 2 is a perspective view to show the surface cooling device of the present invention;

FIG. 3 is an end cross sectional view to show the surface cooling device of the present invention;

FIG. 4 shows another embodiment of the surface cooling device wherein the outlets include guide surfaces;

FIG. 5 is an enlarged view to show the outlet with guide surfaces, and

FIG. 6 is an end view to show the nozzle spray water out from the outlet in FIG. 5.

### DETAILED DESCRIPTION OF THE PREFERRED EMBODIMENT

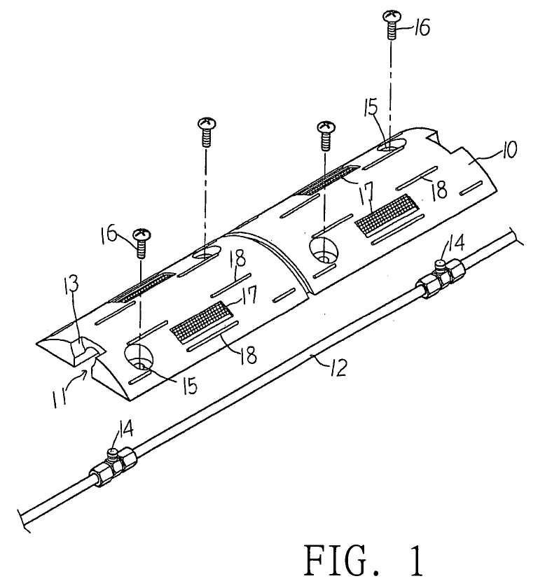

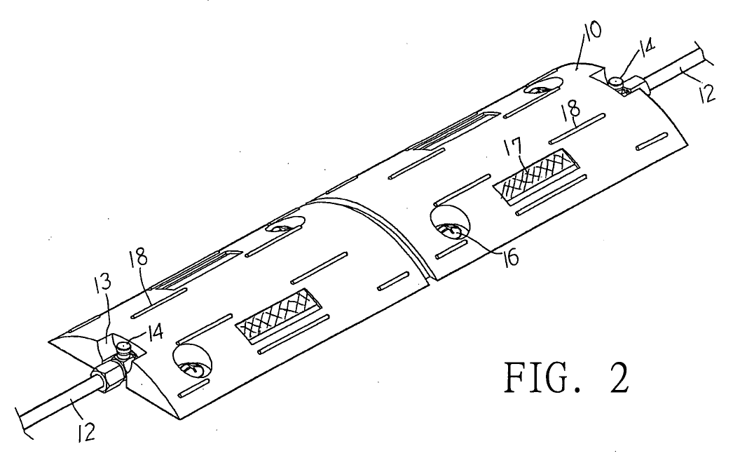

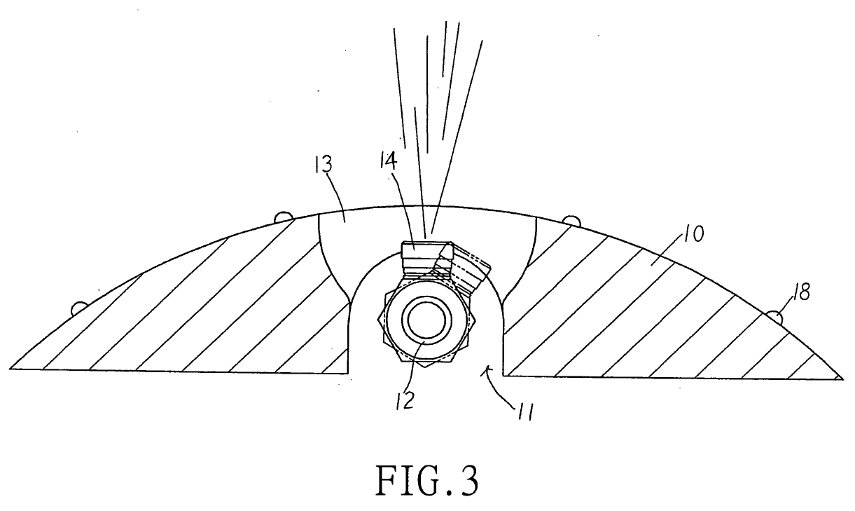

Referring to FIGS. 1 to 3, the surface cooling device of the present invention comprises a cover 10 which includes a curved outer surface and is made by hard material such as plastic the cover 10 includes a plurality of through holes 15 and bolts 16 extend through the through holes 15 and are fixed to the surface such as the road surface. A groove 11 is defined in an underside of the cover 10 and a pipe 12 is engaged with the groove 11. A plurality of nozzles 14 are rotatably connected to the pipe 12 such that water can be ejected out from the nozzles 14. A plurality of outlets 13 are defined through the cover 10 and communicate with the groove 11. The nozzles 14 are rotatably engaged with the outlets 13. Each of the outlets 13 includes an enlarged top opening in the outer surface of the cover 10 and the nozzles 14 are allowed to change its spraying directions within the outlets 13.

The cover 10 includes a plurality of anti-slip ridges 18 extending from the outer surface thereof and a plurality of reflection pieces 17 are connected on the outer surface of the cover 10. The reflection pieces 17 acknowledge the drivers where the covers 10 are located.

The water in the pipe 12 can be properly pressurized so that the water is ejected from the nozzles 14 in a form of small particles which can damp the road surface while no water accumulation in recessed area of the road.

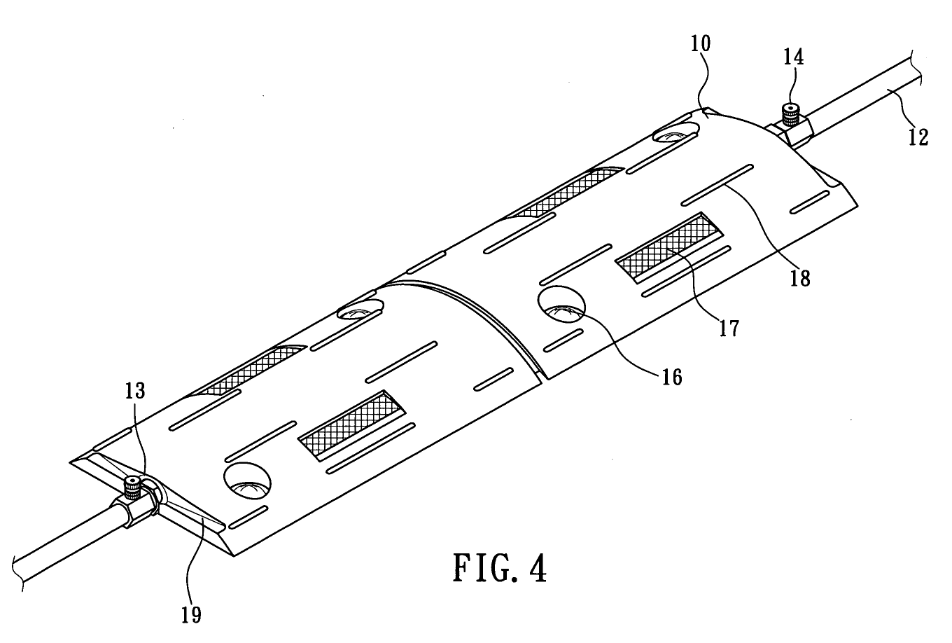

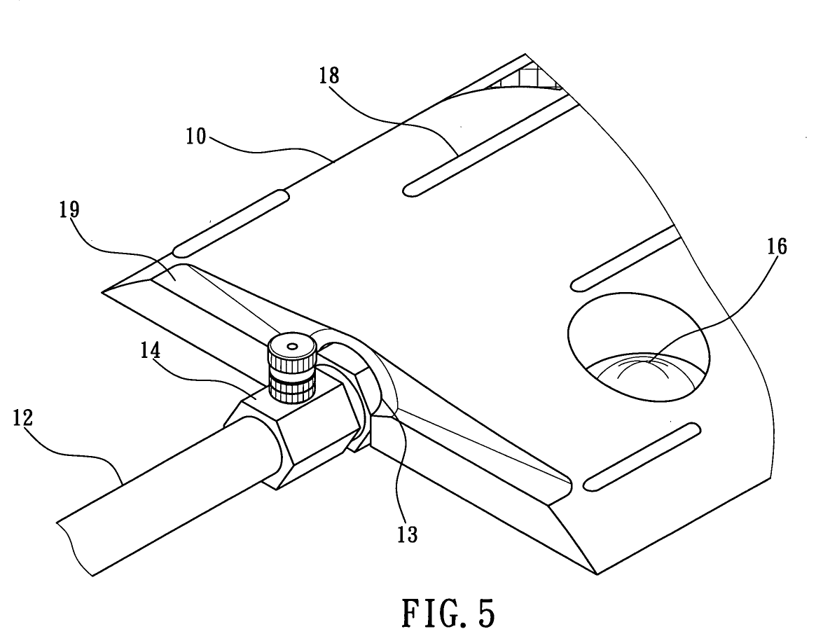

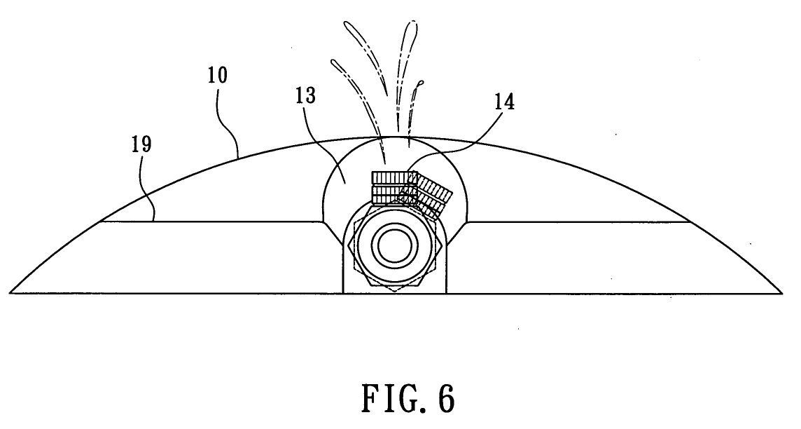

As shown in FIGS. 4 to 6, another embodiment of the cover is disclosed wherein each of the outlets 13 is an elongate recess which includes two guide surfaces 19 which extend from a center of the cover 10 toward two long sides of the cover 10 in an acute angle relative to the underside of the cover 10. The area of each of the guide surfaces 19 increases in radial direction. The wide-opened outlets 13 allow the nozzles 14 to spray within a wider range.

The pipe 12 can be protected by the cover 10 which can be easily fixed on the road surfaces, the water particles reduce dust in the air especially in dry and windy days.

While we have shown and described the embodiment in accordance with the present invention, it should be clear to those skilled in the art that further embodiments may be made without departing from the scope of the present invention.

What is claimed is:

1. A surface cooling device comprising:
a cover adapted to be fixed to a surface and a groove defined in an underside of the cover, a pipe engaged with the groove and a plurality of nozzles connected to the pipe, a plurality of outlets defined through the cover and communicating with the groove, the nozzles engaged with the outlets.

2. The device as claimed in claim 1, wherein each of the outlets includes an enlarged top opening in an outer surface of the cover.

3. The device as claimed in claim 1, wherein the cover includes a plurality of anti-slip ridges extending from an outer surface thereof.

4. The device as claimed in claim 1, wherein the cover includes a plurality of reflection pieces connected on an outer surface thereof.

5. The device as claimed in claim 1, wherein the nozzles are rotatably connected to the pipe.

6. The device as claimed in claim 1, wherein the cover includes a plurality of through holes and bolts extend through the through holes and are adapted to be fixed to the surface.

7. The device as claimed in claim 1, wherein each of the outlets includes at least one guide surface and an area of the at least one guide surface increases in radial direction.
